(19) United States
(12) Patent Application Publication
(10) Pub. No.: US 2024/0414676 A1
(43) Pub. Date: Dec. 12, 2024

(54) Robust Carrier Frequency Offset Estimation

(71) Applicant: Song Howard An, San Diego, CA (US)

(72) Inventor: Song Howard An, San Diego, CA (US)

(21) Appl. No.: 18/680,117

(22) Filed: May 31, 2024

Related U.S. Application Data
(60) Provisional application No. 63/472,259, filed on Jun. 9, 2023.

(51) Int. Cl. H04W 56/00

(52) U.S. Cl. CPC H04W 56/0065

(57) ABSTRACT

A computational method to estimate the carrier frequency offset (CFO) of wireless communication systems using novel phase measurements is disclosed. The computation is carried out in the Diophantine framework defined in this disclosure. It effectively resolves the phase ambiguity (due to 2π crossing) commonly embedded in the phase measurements. The phase ambiguity is an issue for wireless packet communications when a significant initial CFO cannot be synchronized reliably to a common reference packet per packet. A typical application is vehicle to everything (V2X) communications employed by the Intelligent Transportation Systems (ITS) worldwide, as included in the IEEE 802.11 WLAN standard as well as in the 3GPP LTE and 5G standards. An emerging application that needs to address high Doppler frequency is non-terrestrial network (NTN) in 5G wireless communications. The disclosed computational framework offers scalable computational complexity for implementation tradeoff to meet both cost and performance requirements.

### BACKGROUND

The present invention is related to the wireless communication system particularly to the packet communication that requires carrier frequency offset (CFO) estimation in each received packet from different transmitters.

Robust carrier frequency offset estimation and correction is paramount to high mobility and extended range wireless communications such as in the vehicular or non-terrestrial network (NTN) environment. The initial CFO is generally significant due to low cost commercial components and high speed platform (e.g., vehicle or satellite) movement. The typical oscillator for use in commercial standards is 20 parts per million (PPM). In theory the phase information between two selected signal samples represents the frequency offset information. However, the phase measurement often does not represent the true phase information due to 2π crossing event that is known as phase ambiguity. When it occurs, the frequency estimate is bad if it is not treated accordingly. A computational algorithm derived from the Diophantine equations is disclosed to solve the challenges of the phase ambiguity. The disclosed method not only produces robust performance in the demanding conditions but also offers scalable computational complexity. It is shown that the complexity is noticeably less compared to that of the maximum likelihood (ML) approach with comparable performances. The method is applicable to both single input single output (SISO) and multiple input multiple output (MIMO) wireless communications.

### SUMMARY OF THE INVENTION

A method for use to determine the carrier frequency offset (CFO) estimate derived from the Diophantine equations is disclosed. Mathematically, the CFO estimation can be obtained directly from the unwrapped phase information ( ) of a plurality of complex signal samples, that is, Φ=2πfT=2πn+ϕ, where f is the quantity of the CFO, T is the duration of the complex signal samples used, and ϕ is the phase measurement for the duration T apart and |ϕ|≤π, called wrapped phase. The integer n indicates the number of 2π crossing in the T interval and its sign reflects its offset direction from the intended carrier frequency. The unwrapped phase can be reconstructed by a plurality of the wrapped phase measurements (ϕᵢ, at a subinterval Tᵢ=dᵢŤ, i=1 . . . . N, |ϕᵢ|<π, N>1) in which Ť is the time lag unit for dᵢ, 0<d₁<d₂< . . . <d_{N} are relatively prime integers, and Φᵢ=2πfTᵢ=2πnᵢ+ϕᵢ. The parameter nᵢ represents the 2π folding factor of the unwrapped phase Φᵢ normally unknown. It is understood that the frequency estimation error Δf is related to the phase measurement error Δϕ_{N} resulting from the added noise and/or channel fading in the observation interval T_{N}, i.e., Δf=Δϕ_{N}/2π/T_{N}, provided that n_{N} is correctly determined. It is shown that a larger T_{N} will result in a smaller frequency estimation error given a phase error in the measurement. In a communication system, the selection of T_{N} is generally a tradeoff against Δϕ_{N} due to the preamble resource. When |n_{N}|>0, it means the phase ambiguity resulting from 2π crossing occurs in the phase measurements. A computational algorithm that aims at accurate n_{N} calculation is disclosed in this invention. It's shown later that the method in this disclosure achieves robust CFO estimation in the SNR as low as 0 dB in the presence of vehicular multipath fading compared to those obtained from the maximum likelihood approaches in the open literature.

### BRIEF DESCRIPTION OF THE DRAWINGS

FIG. 1 illustrates the top level signal processing flow of the method.

FIG. 2a provides an example of the lag product formation from the received signal samples using the WLAN L-STF periodic preamble.

FIG. 2b provides an example of the lag product formation from the received signal samples using a general preamble.

FIG. 3 illustrates the Diophantine-based algorithm used to estimate the CFO.

FIG. 4a shows the performance advantage (AWGN channel) of the invention compared to that of the maximum likelihood approach in the open literature.

FIG. 4b shows the performance advantage (Highway NLOS channel) of the invention compared to that of the maximum likelihood approach in the open literature.

### DESCRIPTION OF THE INVENTION

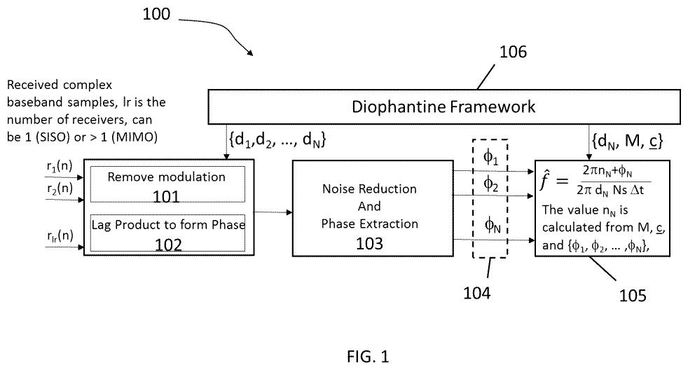

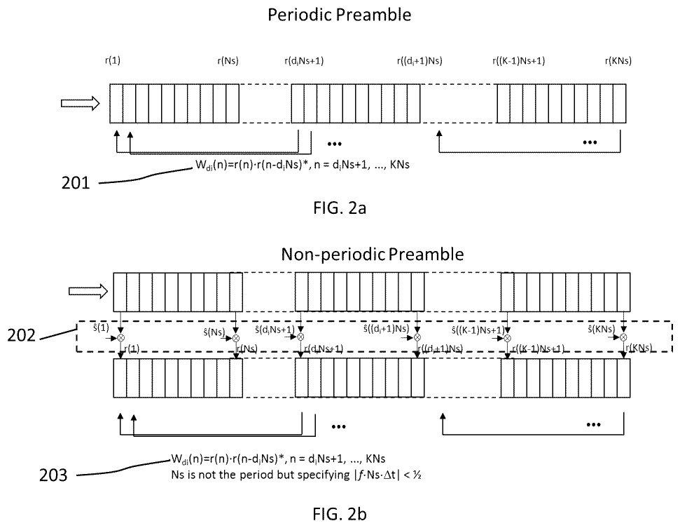

The present invention discloses a design method to solve carrier frequency offset (CFO) estimation reliably using the phase measurements from the selected time intervals that are associated with a relative prime sequence. The underlying computational framework 106 is constructed based on the classical linear Diophantine equations (homogeneous and nonhomogeneous). FIG. 1 illustrates the top level signal processing flow 100 of the method. The key functions consist of modulation removal 101, phase formation 102, noise reduction 103, phase measurements 104 and calculating the frequency estimate 105. These key functions are processed in the Diophantine framework 106. The Diophantine framework 106 is comprised of three key parameters: d=[d₁, d₂, . . . , d_{N}] vector, an M matrix of N−1 rows and N columns, and c=[c₁, c₂, . . . , c_{N-1}] Vector. The Parameter N is the Number of Phase Measurements obtained from the received signal samples. N is a design choice mainly to minimize the probability of error in resolving the folding factor (i.e., phase ambiguity event). In wireless communications, a known preamble is available at the beginning of a communication session. FIG. 2a and FIG. 2b illustrate modulation removal and phase measurement of the periodic and non-periodic preambles, respectively. The processed signal sample, denoted as W_{di} as in Eq. (3), is referred to the lag product (LP) of two selected received signal samples separated by dᵢ timing units so that W_{di} carries the phase info resulting from the CFO. When a periodic preamble is employed, the LP 201 effectively removes the modulation. As a result, the phase measurements are obtained from the phasors of W_{di}. For the non-periodic preamble, modulation removal can be done by correlating the received samples with the know signal pattern 202. The same LP 203 is applied to obtain the phase measurements. Noise reduction by way of “integrate and dump,” as shown in Eq. (4a), is employed to enhance the SNR on the processed signal samples prior to converting to the phase measurements. The noise reduction version of W_{di} is denoted as Z_{di}. Multiple Z_{di}'s are then used to perform frequency estimation. The noise reduction is performed to the maximum extent only limited to the available preamble samples prior to entering the Diophantine framework in which the phase ambiguity is resolved, when it exists, to obtain the true or unwrapped phase information for robust CFO estimate. It's noteworthy that the LP-based method is approaching to the maximum likelihood (ML) algorithm when all the possible LP's are used. But, the ML algorithm does not address how to resolve the phase ambiguity.

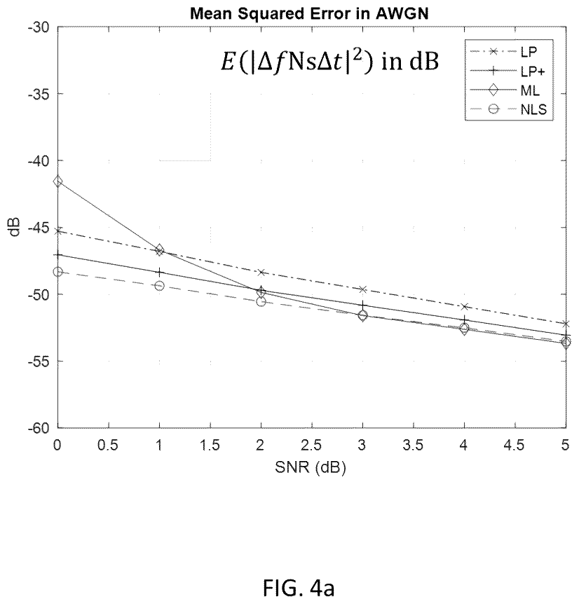

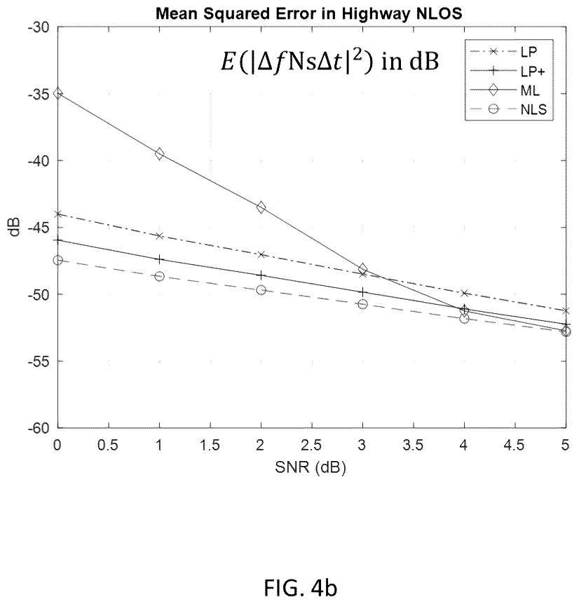

Without loss of generality and for brevity, the classical SISO additive white Gaussian noise (AWGN) communication channel is employed to illustrate the computational algorithm. Thus, Ir is set to 1 in FIG. 1 and the subscript i in the received signal samples rᵢ(n) will be dropped until the MIMO system is considered. The simple channel model is not the limitation of the disclosed method. The performance in a highly dynamic multipath fading channel using the algorithm disclosed in this method has been evaluated and shown in FIG. 4b as a reference. The legacy short training field (L-STF) of the preamble of the IEEE wireless local area network (WLAN) waveform is employed to illustrate the disclosed method. The Diophantine framework in this disclosure is a formation of the classical Diophantine linear equations and does not depend on any specific preamble. As long as the waveform modulation can be removed prior to or jointly with the phase measurements, the framework can apply.

FIG. 2a illustrates the lag product (LP) formation from the received signal samples using the WLAN L-STF periodic preamble 201. Ns in the figure is the period of the L-STF preamble. Taking advantage of the preamble periodicity, the modulation is automatically removed in forming the LP. The condition |f·Ns·Δt|<½, where Δt is the sampling interval, is required that specifies the phase crossing boundary +/−π associated with Ns. The unit interval of the Diophantine integer dᵢ is Ns·Δt. For example, if dᵢ=3 and Ns=16, the phase measurement ϕᵢ is obtained from 48 signal samples apart, that is, ϕᵢ=mod (2π·f·dᵢ·Ns·Δt|2π) in which the modulo operation z=mod (x|y) is given as x=k·y+z, k is an integer. Effectively, the maximum CFO that can be estimated is fₛ/2/Ns where fₛ is the sampling rate of the incoming samples defined as fₛ=1/Δt. In general 203, Ns is a design parameter selected to ensure that the maximum CFO can be estimated.

The received baseband sample r (n) in complex representation is shown as follows

$$r ( n ) = s ( n ) {e}^{j ( 2 π f n Δ f + θ )} + w ( n ) \qquad ( 1 )$$

where θ is the initial phase of the received sample at n=0, s (n) represents the transmitted signal, and w(n) is the AWGN with the variance 2σ². The L-STF is at very beginning of the WLAN preamble for each packet. It has 10 repeated signal pattern {αₜ, t=1 . . . 16}, in which αₜ is a known complex signal. Denote the number of repeated signal pattern by K. As a result, Ns=16 and K=10 from the IEEE WLAN L-STF will be used in the exemplified illustrations. In the real world of operation, the first one or two signal patterns is used for signal detection. As such, less than 10 repeated patterns is available for the CFO estimation. The property of the periodic preamble is shown below

$$s ( t ) = {α}_{t} , for t = 1 , 2 , … , Ns \qquad ( 2 a )$$

$$s ( t + k \cdot Ns ) = s ( t ) , for t = 1 , 2 , … , Ns , k = 1 , 2 , … , ( K - 1 ) \qquad ( 2 b )$$

For a dᵢϵ{d₁, d₂, . . . , d_{N}}, the processed signal sample W_{di}(n) is defined as the lag product of two received samples with the time lag dᵢ units as follows

$${W}_{d i} ( n ) = r ( n ) \cdot {r ( n - {d}_{i} \cdot Ns )}^{*} , where {d}_{i} \cdot Ns + 1 \leq n \leq K \cdot {N}_{s} \qquad ( 3 )$$

where * indicates the complex conjugate operation. Denote Z_{di} as follows

$$\begin{matrix}{Z}_{di} = {\sum }_{n = {d}_{i} \cdot Ns + 1}^{K \cdot Ns} {W}_{di} ( n ) \\ = {X}_{s} {e}^{j ( 2 π f {d}_{i} Ns \cdot Δ t )} + {X}_{w} {=}^{Δ} {X}_{s} {e}^{j {ϕ}_{i}} + {X}_{w}\end{matrix} \qquad \begin{matrix}( 4 a ) \\ ( 4 b )\end{matrix}$$

where Xₛ is the desired signal and X_{w} is the unwanted signal as shown below

$${X}_{s} = ( K - {d}_{i} ) {\sum }_{t = 1}^{N s} {\vert {α}_{t} \vert}^{2} \qquad ( 5 )$$

$${X}_{w} = {\sum }_{k = {d}_{i}}^{K} {\sum }_{t = 1}^{N s} {α}_{t} {e}^{j ( k \cdot Ns + t + θ )} {w}^{*} ( ( k - {d}_{i} ) \cdot Ns + t ) + {α}_{t}^{*} {e}^{- j ( ( k - {d}_{i} ) N s + t + θ )} w ( k \cdot Ns + t ) + w ( k \cdot Ns + t ) \cdot {w}^{*} ( ( k - {d}_{i} ) \cdot Ns + t ) \qquad ( 6 )$$

The properties in Eqs. (2a) and (2b) have been employed to yield Xₛ and X_{w}. As shown in Eq. (4b), the phase measurement ϕᵢ is the angle of Z_{di} corrupted by noise. Z_{di} is the noise reduction version of W_{di}(n) via the “integrate and dump” operation so the SNR is improved accordingly before turning into the phase measurement.

For a non-periodic preamble as illustrated in FIG. 2b, modulation is removed before forming the lag product as

$$r ( n ) ← r ( n ) \cdot {\hat{s} ( n )}^{*} \qquad ( 7 a )$$

$${W}_{d i} ( n ) = r ( n ) \cdot {r ( n - {d}_{i} \cdot Ns )}^{*} \qquad ( 7 b )$$

where {ŝ(n)} is the power-normalized {s(n)}, and Ns is a selection such that |f·Ns·Δt|<½. The operator ← refers to content replacement to keep the same notation.

It is evident that the disclosed method is applied to any non-preamble data, for example like a phase-shifted keying (PSK) signal once the modulation is removed with other techniques.

In a MIMO system having It transmit and Ir receive paths, the received signal at the k^{th} receive path is

$${r}_{k} ( n ) = {\sum }_{l = 1}^{lt} {h}_{kl} {s}_{l} ( n ) {e}^{j ( 2 π fn Δ t + θ )} + {w}_{k} ( n ) \qquad ( 8 )$$

where {hₖₗ} is the complex channel characteristic from the l^{th} transmit path to the k^{th} receive path. A MIMO system generally utilizes a periodic orthogonal sequence in the preamble to aid channel estimation, that is Σₙ₌₁^{Ns}ŝₖ(n)ŝ*ₗ(n)=0, for k≠l and Σₙ₌₁^{Ns}ŝₖ(n)ŝ*ₗ(n)=1, for k=l. Applying ŝₖ(n) to the k^{th} receive path to remove the preamble modulation as

$${r}_{k} ( n ) ← {r}_{k} ( n ) \cdot {{\hat{s}}_{k} ( n )}^{*} \qquad ( 9 )$$

and taking advantage of the orthogonal property, Z_{di} for the MIMO system can be shown having the same form as the SISO system

$${Z}_{d i} = {\sum }_{k = 1}^{lr} {X}_{s , k} {e}^{i {ϕ}_{i}} + {X}_{w , k} \qquad ( 10 )$$

where X_{s,k} is the desired and X_{w,k} is the unwanted signal at the k^{th} receive path.

Eq. (10) is a result from assuming the same clock for each transmit path such as in an Access Point device of the WLAN or the synchronized multiple clocks such as in the base stations of the 4G/5G mobile communications. The synchronizations among multiple oscillators in a base station or a general near-by area can be achieved by the same computational technique discussed in this disclosure. It will be illustrated briefly later on.

{ϕ₁, ϕ₂, . . . , ϕ_{N}} obtained from Z_{di} for each dᵢϵ{d₁, d₂, . . . , d_{N}} is then applied to the Diophantine framework to calculate the CFO estimate in the following.

An unwrapped phase (denoted as Φᵢ) is referred to a true phase mathematically. But in the measurement it can only be represented by its remainder of the Euclidean division of 2π. The remainder is called the wrapped phase (denoted as ϕᵢ), namely,

$${Φ}_{i} = 2 π f \check{T} {d}_{i} = 2 π {n}_{i} + {ϕ}_{i} \qquad ( 11 )$$

where Ť is the time unit used by dᵢ and −π≤ϕᵢ<π. As shown previously, Ť=Ns·Δt. The integer nᵢ representing the phase folding factor is function of the CFO f to be estimated and the interval dᵢŤ·Ť is a design choice but follows |fŤ|<½ and thus |nᵢ|<dᵢ/2.

The following linear Diophantine equations are considered in the algorithm derivation.

$$Homogeneous : {\sum }_{q = 1}^{N} {{m}^{´}}_{q} {d}_{q} = 0 \qquad ( 12 )$$

$$Nonhomogeneous : {\sum }_{q = 1}^{N} {i}_{q} {d}_{q} = 1 \qquad ( 13 )$$

where {\acute{m}_{q}} and {i_{q}}, q=1, 2, . . . , N, are all integers. (N−1) homogeneous and one nonhomogeneous equations are needed for processing N phase measurements {ϕ₁, ϕ₂, . . . , ϕ_{N}}. {\acute{m}_{q}} is to be replaced by {m_{pq}} subsequently to represent multiple homogenous equations. The index p with 1≤p≤(N−1) indicates up to N−1 sets of {\acute{m}_{q}} employed. All N−1 sets have to be pairwise independent.

To illustrate the insights of the computational algorithm in the following, N=3 is used as an example to ensure clarity. The extension to N>3 is immediate. Dividing 2π on both sides of Eq. (11) results in the following three expressions

$$f \check{T} {d}_{1} = {n}_{1} + {φ}_{1} \qquad ( 14 a )$$

$$f \check{T} {d}_{2} = {n}_{2} + {φ}_{2} \qquad ( 14 b )$$

$$f \check{T} {d}_{3} = {n}_{3} + {φ}_{3} \qquad ( 14 c )$$

where φᵢ=ϕᵢ/2π, so |φᵢ|≤½; n₃ associated with the longest interval d₃ is to be solved in order to compute the frequency estimate. Applying the linear Diophantine questions on the left side of Eqs. (14a), (14b), (14c) leads to the following three equations (fŤ is dropped for brevity)

$${m}_{11} {d}_{1} + {m}_{12} {d}_{2} + {m}_{13} {d}_{3} = 0 \qquad ( 15 a )$$

$${m}_{21} {d}_{1} + {m}_{22} {d}_{2} + {m}_{23} {d}_{3} = 0 \qquad ( 15 b )$$

$${i}_{1} {d}_{1} + {i}_{2} {d}_{2} + {i}_{3} {d}_{3} = 1 \qquad ( 15 c )$$

Firstly, dividing Eqs. (15a) and (15b) by d₃, multiplying them by integer c₁ and c₂, respectively, and then adding them to Eq. (15c), result in the following expression

$$\{ {c}_{1} {m}_{11} + {c}_{2} {m}_{21} + {i}_{1} {d}_{3} ) {d}_{1} / {d}_{3} + \{ {c}_{1} {m}_{12} + {c}_{2} {m}_{22} + {i}_{2} {d}_{3} ) {d}_{2} / {d}_{3} + \{ {c}_{1} {m}_{13} + {c}_{2} {m}_{23} + {i}_{3} {d}_{3} - 1 ) = 0 \qquad ( 16 )$$

This is effectively adding zero sums from Eqs. (15a) and (15b) to Eq. (15c). Since the terms d₁/d₃ and d₂/d₃ are not only non-zeros but also distinct positive fractional numbers appearing in an integer equation, the immediate condition among others for Eq. (16) to hold is to make c₁ and c₂ such that c₁m₁₁+c₂m₂₁+i₁d₃=0, c₁m₁₂+c₂m₂₂+i₂d₃=0, and c₁m₁₃+c₂m₂₃+i₃d₃−1=0. From the first two zero terms, it is justified that {c₁, c₂} must exist because {m_{pq}} are independent in any two rows by selection. If the {c₁, c₂} obtained from the two zero terms can also make c₁m₁₃+c₂m₂₃+i₃d₃−1=0, Eq. (16) is validated. Putting these three zero terms into a matrix form leads to

$$[ \begin{matrix}{m}_{11} & {m}_{21} \\ {m}_{12} & {m}_{22} \\ {m}_{13} & {m}_{23}\end{matrix} ] [ \begin{matrix}{c}_{1} \\ {c}_{2}\end{matrix} ] = [ \begin{matrix}{i}_{1} {d}_{3} \\ {i}_{2} {d}_{3} \\ {i}_{3} {d}_{3} - 1\end{matrix} ] \qquad ( 17 )$$

Note that −1 has been absorbed into c₁ and c₂ maintaining the validity of Eq. (17). Since the prerequisite of forming more than one set of homogeneous equations is that they must be independent pairwise, | m₁₁m₂₂−m₁₂m₂₁| must be nonzero. This guarantees that c=[c₁ c₂]^{T} can be obtained from the top two rows of Eq. (17). The superscript T indicates the transpose operation. To prove the third row of Eq. (17), denote the 2×3 M and 2×2 U matrices and 2×1 m₃ vector as follows

$$M = [ \begin{matrix}{m}_{11} & {m}_{12} & {m}_{13} \\ {m}_{21} & {m}_{22} & {m}_{23}\end{matrix} ] = [ ⋃ ⋮ {\underline{m}}_{3} ] \qquad ( 18 a )$$

$$where ⋃ = [ \begin{matrix}{m}_{11} & {m}_{12} \\ {m}_{21} & {m}_{22}\end{matrix} ] and {\underline{m}}_{3} = [ \begin{matrix}{m}_{13} \\ {m}_{23}\end{matrix} ] \qquad ( 18 b )$$

Furthermore, denote [symbol] =[d₁ d₂]^{T}, and ĭ=[i₁ i₂]^{T}. Eqs. (15a) and (15b) can be rewritten in a matrix form as

$$⋃ = - {d}_{3} {\underline{m}}_{3} \qquad ( 19 a )$$

On the other hand, the top two rows of Eq. (17) can be rewritten as

$${⋃}^{T} \underline{c} = {d}_{3} \breve{I} \qquad ( 19 b )$$

Plugging Eq. (19a) and (19b) into the left of the third row of Eq. (17) becomes

$${\underline{m}}_{3}^{T} \underline{c} = {T}^{} {⋃}^{T} ( 1 / {d}_{3} ) {( {⋃}^{T} )}^{- 1} \breve{I} {d}_{3} = {⊤}^{} \breve{I} = - ( {i}_{1} {d}_{1} + {i}_{2} {d}_{2} ) = {i}_{3} {d}_{3} - 1 \qquad ( 19 c )$$

QED. It will be shown next that the third row equality of Eq. (17) is the key to solve the 2π crossing number n_{N} that is in turn needed to calculate the CFO f. The extension to prove Eq. (17) in a generic N>3 is readily straightforward simply replacing 3 by N and adding associated terms up to N.

Eqs. (15a) and (15b) can be rewritten to the following, replacing d; by the right hand side of Eqs. (14a), (14b), and (14c)

$${m}_{11} {n}_{1} + {m}_{12} {n}_{2} + {m}_{13} {n}_{3} + {m}_{11} {φ}_{1} + {m}_{12} {φ}_{2} + {m}_{13} {φ}_{3} = 0 \qquad ( 20 a )$$

$${m}_{21} {n}_{1} + {m}_{22} {n}_{2} + {m}_{23} {n}_{3} + {m}_{21} {φ}_{1} + {m}_{22} {φ}_{2} + {m}_{23} {φ}_{3} = 0 \qquad ( 20 b )$$

In the noise free condition, m₁₁φ₁+m₁₂φ₂+m₁₃φ₃ and m₂₁φ₁+m₂₂φ₂+m₂₃φ₃ are integers due to summing to zero with some other integers. Denote them as follows

$${η}_{1} = {m}_{11} {φ}_{1} + {m}_{12} {φ}_{2} + {m}_{13} {φ}_{3} \qquad ( 21 a )$$

$${η}_{2} = {m}_{21} {φ}_{1} + {m}_{22} {φ}_{2} + {m}_{23} {φ}_{3} \qquad ( 21 b )$$

Note that η₁ and η₂ are the results of multiplying the normalized received phases with the {m_{pq}} coefficients. Following the same arithmetic procedure leading to Eq. (16), multiplying Eqs. (20a) and (20b) by c₁ and c₂, respectively, and combining them lead to

$$( {c}_{1} {m}_{11} + {c}_{2} {m}_{21} ) {n}_{1} + ( {c}_{1} {m}_{12} + {c}_{2} {m}_{22} ) {n}_{2} + ( {c}_{1} {m}_{13} + {c}_{2} {m}_{23} ) {n}_{3} + {c}_{1} {η}_{1} + {c}_{2} {η}_{2} = 0 \qquad ( 22 )$$

Applying the equality terms in Eq. (17) into Eq. (22), it becomes

$${i}_{1} {d}_{3} {n}_{1} + {i}_{2} {d}_{3} {n}_{2} + ( {i}_{3} {d}_{3} - 1 ) {n}_{3} + {c}_{1} {η}_{1} + {c}_{2} {η}_{2} = 0 \qquad ( 23 )$$

Applying modulo d₃ onto Eq. (23), n₃ can be determined as

$${n}_{3} = mod \{ {c}_{1} {η}_{1} + {c}_{2} {η}_{2} \vert {d}_{3} ) \qquad ( 24 a )$$

Recall that |n₃|<d₃/2. If n₃>d₃/2 from Eq. (24a), n₃ is adjusted to

$${n}_{3} ← {n}_{3} - {d}_{3} \qquad ( 24 b )$$

n₃ obtained here is then applied to Eq. (14c) to calculate the CFO f estimate.

Up to this point, the noise free condition is considered in the algorithm derivation. The only requirements are that all integers {m_{pq}} and {i_{q}} for p=1, 2, N−1, and q=1, 2, . . . , N must satisfy the linear Diophantine equations in Eqs. (12) and (13), respectively, and that {m_{pq}, q=1, 2, . . . , N} set must be pairwise independent for any two p's. In another word, given a selected d=[d₁, d₂, . . . , d_{N}] design, there are multiple M and c that the algorithm will work. However, in the real world of operation, added noise and/or channel fading may introduce unwanted signal in the received samples, and thus the phase measurements {ϕ₁, ϕ₂, . . . , ϕ_{N}}, equivalently {φ₁, φ₂, . . . , φ_{N}}, are corrupted. The following is to assess what additional considerations are needed in finding M and c to ensure high reliability of the algorithm.

Denote the unwanted signal in φᵢ as εᵢ and define the following

$${Δη}_{1} = {m}_{11} {ε}_{1} + {m}_{12} {ε}_{2} + {m}_{13} {ε}_{3} \qquad ( 25 a )$$

$${Δη}_{2} = {m}_{21} {ε}_{1} + {m}_{22} {ε}_{2} + {m}_{23} {ε}_{3} \qquad ( 25 b )$$

Adding the unwanted term εᵢ to each φᵢ in Eqs. (20a) and (20b), η₁+Δη₁ and η₂+Δη₂ are no longer integers that are required for the computing n₃ correctly according to Eq. (24a) or Eq. (24b). Hence, it requires that the algorithm perform a function such as rounding off (η₁+Δη₁) and (η₂+Δη₂), respectively, to obtain η₁ and η₂ correctly before calculating n₃. As a result, |Δη₁|<½ and |Δη₂|<½ are two additional requirements in selecting M in order for getting reliable n₃ calculation and subsequently reliable frequency estimate. Since εᵢ is a noise term in each φᵢ, there is a distribution associated with it. It can be stated that M is selected such that

$$Pr ( \vert {m}_{11} {ε}_{1} + {m}_{12} {ε}_{2} + {m}_{13} {ε}_{3} \vert \geq 1 / 2 ) < ζ \qquad ( 26 a )$$

$$Pr ( \vert {m}_{11} {ε}_{1} + {m}_{12} {ε}_{2} + {m}_{13} {ε}_{3} \vert \geq 1 / 2 ) < ζ \qquad ( 26 b )$$

where ζ is normally a very small number such as 10⁻² or less. It's often related to the packet error rate designed in a wireless communication system. The paper entitled “Distribution of the Phase Angle between Two Vectors Perturbed by Gaussian Noise” by R. F. Pawula, S. O. Rice, J. H. Roberts in IEEE Transactions on Communication, August 1982 is a good reference for determining the probabilities shown in Eqs. (26a) and (26b). From the system design point of view, M is selected such that σ_{η1} and θ_{η2} are minimized in which

$${σ}_{η 1}^{2} = {m}_{11}^{2} {σ}_{ε 1}^{2} + {m}_{12}^{2} {σ}_{ϵ 2}^{2} + {m}_{13}^{2} {σ}_{ϵ 3}^{2} \qquad ( 27 a )$$

$${σ}_{η 2}^{2} = {m}_{21}^{2} {σ}_{ε 1}^{2} + {m}_{22}^{2} {σ}_{ϵ 2}^{2} + {m}_{23}^{2} {σ}_{ϵ 3}^{2} \qquad ( 27 b )$$

As shown, θ_{ηk} (k=1, 2, . . . , N−1) is determined by the elements in M and all σ_{εi}, i=1, 2, . . . , N. Intuitively, the absolute value of m_{pq} as small as possible is preferred in forming M for any given {σ_{εi}}. On the other hand, σ_{εi} is the result from noise reduction for a given dᵢ. Eq. (6) shows how it is related to the noise reduction process. As shown, σ_{εi} are not the same because dᵢ are distinct. From the system design perspective, minimizing σ_{εi} resulting from noise reduction is preferred to ensure reliable calculation (i.e., smaller σ_{ηk}) given an M matrix. The processes of selecting the rows for M and minimizing {θ_{εi}} are separate tasks but they both are related to the d vector. The ultimate objective is that they must meet or exceed the error probability specified in the design requirements as shown in Eqs. (26a) and (26b).

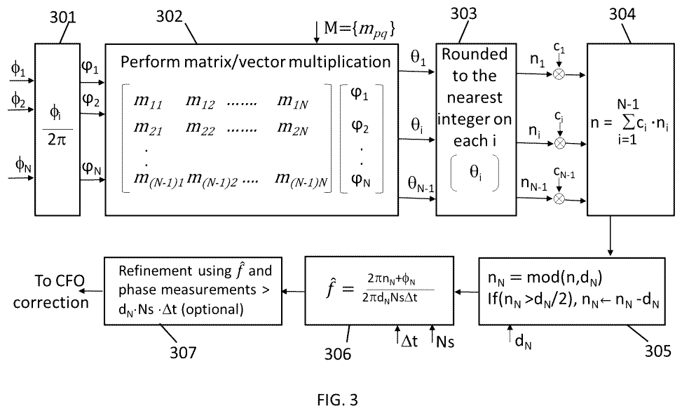

In summary, the computational algorithm derived from the Diophantine equations is illustrated in FIG. 3 and outlined as follows:
1) Prepare the Diophantine framework 106: a relatively prime time lag vector d=[d₁, d₂, . . . , d_{N}], a matrix M from N−1 sets of linear Diophantine homogeneous equations of d as shown in Eq. (12), and a vector c=[c₁, c₂, . . . , c_{N-1}]^{T} derived from M and a linear Diophantine nonhomogeneous equation as shown in Eq. (13). d and M are selected to minimize the probability of erroneous n_{N} calculation in the presence of noise to meet the system performance requirements as shown in Eqs. (26a) and (26b).
2) Obtain N phase measurements {ϕ₁, ϕ₂, . . . , ϕ_{N}} 103, 104 with respect to the time lag specified in d.
3) Divide each phase measurements by 2π 301 to form φ=[φ₁, φ₂, . . . , φ_{N}], where |φᵢ|≤½.
4) Multiply M by φ^{T} 302, and then round off each element to form an (N−1)×1 integer vector as η=<M φ^{T}> 303 where <M φ^{T}> is the round off operator to yield the nearest integer in each element of the resultant vector.
5) Multiply c^{T} with η 304, perform the modular function 305 to yield n_{N} as mod (c^{T}·η|d_{N}).
6) If n_{N}>d_{N}/2, adjust n_{N}←n_{N}−d_{N} 305
7) Calculate the f estimate as

$$\hat{f} = \frac{2 π {n}_{N} + {ϕ}_{N}}{2 π {d}_{N} \check{T}} 306 \qquad ( 28 )$$

As shown in Eq. (28), there are two factors determining the accuracy of the f estimate, n_{N} and ϕ_{N}. The unwanted error of ON can be compensated by choosing a larger d_{N}. However, a larger d_{N} may result in larger ε_{N} because less noise reduction effect results from smaller K−d_{N} according to Eqs. (5) and (6). Consequently it is not a favorable condition for obtaining accurate n_{N}. In the system design, two steps are generally considered. The first is to choose N and d_{N} to ensure reliable n_{N} calculation. The f estimate can be further refined 307 to gain more accuracy by employing θₖⱼ, the angle of Zₖⱼ, in which d_{N}<kⱼ<K, j=1, . . . . J, and J is the number of terms used to performance refinement. Recall that K is the available replicas of the repeated preamble. The following is the refinement procedure 307.

$${ϑ}_{kj} = arg ( {Z}_{kj} {e}^{- j2 π \hat{f} {k}_{j} \check{T}} ) \qquad ( 29 a )$$

$$δ {f}_{kj} = {ϑ}_{kj} / 2 π {k}_{j} \check{T} \qquad ( 29 b )$$

$$\hat{f} ← \hat{f} + ( {\sum }_{j = 1}^{j} δ {f}_{kj} ) / ( J + 1 ) \qquad ( 29 c )$$

The refinement is an important merit resulting from the structured computational framework. J can be zero to save computational loading if the performance has been met. When J=0, Eqs. (29a) (29b) and (29c) are skipped. Taking advantage of the structured framework, that is choosing d=[d₁, d₂, . . . , d_{N}] and M to maximize the reliability of computing n_{N} and subsequently perform frequency estimate refinement using the phases of the longer time lags is a novel idea. It facilitates the merits of scalable computational complexity and tradeoffs.

The performance of the disclosed method is evaluated via extensive simulations. The IEEE WLAN preamble is employed as the example; specifically K=9 and Ns=16 periodic preamble is used. The first period is used for detection. In addition to the AWGN, the Highway non-line-of-sight (NLOS) channel model in the ETSI (European Telecommunication Standards Institute) standard: Intelligent Transport System Access Layer (ETSI 103 257-1) is considered in the performance evaluation. Two computational methods from the open literature are also evaluated for the performance comparison. They are Maximum Likelihood (ML) based on “Maximum Likelihood Timing and Carrier Frequency Offset Estimation for OFDM Systems With Periodic Preambles” by H. T. Hsieh and W. R. Wu published in IEEE Transactions on Vehicular Technology, October 2009, and Nonlinear Least Squares (NLS) based on “Carrier Frequency Offset Estimation for OFDM-Based WLANs” by J. Li, G. Liu, and G. B. Giannakis published in IEEE Signal Processing Letters, March 2001. The NLS method is selected mainly as the performance reference due to that it uses extensive search approach. It's non-implementable in hardware but provides the theoretical insight. The ML method is commonly considered in academia and industry. It often leads to some variants due to different assumptions to implement in the hardware. Two cases from the disclosure are evaluated. They are labelled LP and LP+. The LP is referred to the computational procedure as shown in Eq. (28). The LP+ is referred to including additional refinement as shown in Eqs. (29a), (29b), and (29c) following the LP procedure. Specifically, N=2 (two phase measurements) and d_{N}=3 (the longest time lag for computing n_{N}) are implemented in the simulations; that is, Z₁ and Z₃ are used for the frequency estimate. Subsequently Z₇ is used for estimate refinement. 30,000 packets are generated in the simulations for the AWGN and the NLOS vehicular environment separately. The CFO to be estimated in the simulations is uniformly distributed over ±40 PPM. The IEEE WLAN standard specifies 20 PPM for each device to operate in its network. To ensure meaningful comparisons, the same input waveform is evaluated by the four approaches in parallel in each trial. The results are shown in FIG. 4a and FIG. 4b for illustrations. The LP and the LP+ follow nicely with the NLS in performance. The LP+ brings the performance closer to that of the NLS. The ML starts degrading at SNR 2 dB and 4 dB, respectively, for the AWGN and the Highway NLOS channel. Since the modern wireless communication system utilizes low density parity code (LDPC) or Turbo code for forward error correction (FEC), the low SNR operating point such as 0 dB is expected from the system design perspective. The ML performance does not look favorable to this requirement in the real world (e.g., using 20 PPM oscillator) particularly in the dynamic vehicular environment. In addition, the computational loads of the LP and the LP+ are much lower than that of the ML. Approximately, they incur 39% and 45% of the multiplications, respectively, compared to the multiplications needed for the ML. Note that more than 50% computational complexity saving consumes only a little bit performance expense that results in little impact to the subsequent tracking as needed. In conclusion, it is evident that the disclosed method brings performance as well as implementation merits to the wireless communication field operating in the demanding conditions such as low cost commercial parts, extended range, and high mobility environment.

As mentioned earlier, the disclosed method can be used to synchronize two separate oscillators. It is illustrated briefly herein. The objective is to estimate the relative PPM (denoted as rPPM) of the carrier 2 with respective to the carrier 1. The carriers can be measured on the wire or wirelessly. They are denoted by f₁ and f₂, respectively, and related as f₁=(1+rPPM)·f₂. It is assumed that the oscillator 1 transmits a carrier the oscillator 2. In the ideal condition, they are the same frequency but they are not in reality due to the presence of rPPM. The task is to estimate rPPM at the oscillator 2. The RF front end designs can be various. Without loss of generality, the under-sampling approach is considered for illustration. Denote fₛ as the sampling rate. Let's choose f₂=N·fₛ and denote the carrier signal received at the oscillator 2 as

$$r ( t ) = {e}^{j ( 2 π {f}_{1} t + θ )} + w ( t ) = {e}^{j ( 2 π ( 1 + p ) {f}_{2} t + θ )} + w ( t ) \qquad ( 30 a )$$

where p=rPPM, w(t) is AWGN. The digitalized version of Eq. (30a) is represented as

$$r ( n ) = {e}^{j ( 2 π ( 1 + p ) {f}_{2} \frac{n}{{f}_{s}} + θ )} + {w}_{n} = {e}^{j ( 2 π ( 1 + p ) N n + θ )} + {w}_{n} \qquad ( 30 b )$$

Take the lag product of two digitized samples with the time lag K, it can be represented as

$${Z}_{K} = {e}^{j 2 π ( 1 + p ) NK} + {u}_{K} \qquad ( 31 a )$$

$$Phasor of {Z}_{K} = Arg ( {Z}_{K} ) \hat{=} {φ}_{K} + {ε}_{K} \qquad ( 31 b )$$

where u_{K} is the lumped noise term, Ox is the wrapped phase resulting from non-zero rPPM and ε_{K} is the angular noise. The true phase resulting from non-zero rPPM can be represented as 2πn_{K}+φ_{K}+ε_{K}. Again, n_{K} is not shown in the phase measurement but can be computed using the disclosed method. Then the p is obtained as

$$p = \frac{2 π {n}_{K} + {ϕ}_{K} + {ε}_{K}}{2 π NK} \qquad ( 32 )$$

Recall that ε_{K} is the angular noise determined by the SNR. It is a limiting factor to obtain high accuracy of the p estimate. Since N and K are design parameters they can be chosen to attain desired accuracy of the p estimate given ε_{K}. When N·K is large enough to result in |n_{K}|>0, multiple Z_{K} will be needed to resolve n_{K}. As a result, the disclosed method can be employed to perform the computation. A numerical example is provided as follows. Let's assume two separate 1 ppm oscillators. The rPPM is thus +/−2 ppm. A 2 GHz carrier is transmitted from the oscillator 1 to the oscillator 2 with the SNR being 15 dB. Since the oscillator 2 is the receiver, set f₂=2 GHz and f₁ is then equal to 2·(1+rPPM) GHz. By design, choose fₛ=1 MHz. Let's further choose two K values K1=100 and K2=300, i.e., using two phases Arg (Z_{K1}) and Arg (Z_{K2}), to compute n_{K}. K value is K2 in this example. It's shown that the rPPM is reduced from +/−2 ppm to a sigma of 0.05 ppm in 0.3 milli-sec. It is the statistics from 10,000 independent trials. A smaller sigma can be achieved accordingly by choosing proper N and K.

What is claimed is:

1. A method for estimating the carrier frequency offset (CFO) of the received signal in packet communications, the method comprising:
forming a plurality of phase measurement ϕᵢ from the received signal samples, and
ϕᵢ is measured at the time lag dᵢ·Ns·Δt, and dᵢ, i=1, 2, . . . , N are relatively prime integers
the phase measurement ϕᵢ is the angle of the SNR enhanced lag product of two received signal samples as Z_{di}=Σ_{n-d}_{_{i-Ns+1}}^{K·Ns}W_{di}(n) wherein W_{di}(n)=r(n)·r(n−dᵢ·Ns)*, and
the phase measurement set {ϕᵢ, i=1, 2, . . . , N} is applied to a frequency estimation procedure.

2. The said relatively prime integers as recited in claim 1 includes the special case such as pairwise coprime integers.

3. The said lag product Z_{di} as recited in claim 1 can be obtained from the summation of the components with the same distance dᵢ in the covariance matrix of the received signal; The covariance matrix is R=[rᵢⱼ], 1≤i≤K, i≤j≤K, rᵢⱼ=Σₖ₌₁^{Ns} r((j−1)Ns+k)r((i−1)Ns+k)*, and |i−j|=dᵢ.

4. The said frequency estimation procedure as recited in claim 1 is carried out in a Diophantine framework.

5. The said received signal as recited in claim 1 contains a known preamble sequence, either periodic or non-periodic.

6. The said Diophantine framework as recited in claim 4 comprising three pillars:
a. d=[dᵢ, i=1, 2, . . . , N], 1×N vector, contains the time lags of the phase measurements, dᵢ are relatively prime integers, and
b. M is an (N−1)×N matrix in which each row contains the coefficients of the Diophantine homogeneous equation; They are pairwise independent for every two rows, and
c. c=(U^{T})⁻¹ĭd_{N}, ĭ=[i₁, i₂, . . . , i_{N-1}]^{T}, M=[U m_{N}] in which U is an (N−1)×(N−1) matrix in M and m_{N} is an (N−1)×1 vector, and i contains the first N−1 coefficients in the Diophantine nonhomogeneous equation as Σ_{q=1}^{N} i_{q}d_{q}=1.

7. The said frequency estimation procedure as recited in claim 4 comprising the steps of:
a. computing η=<M φ^{T}> where the operator <x> is the round off operator to yield the nearest integer in each element of the vector x, and φ=ϕ/2π. ϕ=[ϕ₁, ϕ₂, . . . , ϕ_{N}] contains the phase measurements from claim 1, and
b. computing the 2π crossing number at d_{N} as n_{N}=mod(c^{T}·η|d_{N}), and
c. adjust n_{N}←n_{N}−d_{N}, if n_{N}>d_{N}/2, and
d. calculate the f estimate as
$$\hat{f} = \frac{2 π {n}_{N} + {ϕ}_{N}}{2 π {d}_{N} \check{T}} , where \check{T} = Ns \cdot Δ t .$$

8. The formation of M in claim 6, is aimed to minimize the probability of erroneous n_{N} calculation as
$${max}_{1 \leq p \leq ( N - 1 )} Pr ( \vert {\sum }_{q = 1}^{N} {m}_{pq} {ε}_{q} \vert \geq 1 / 2 ) < ζ ,$$
where ζ is related to the performance requirement for example like the packet error rate, normally a small number such as 10⁻² or less.

9. The said system design criterion
$${max}_{1 \leq p \leq ( N - 1 )} Pr ( \vert {\sum }_{q = 1}^{N} {m}_{pq} {ε}_{q} \vert \geq 1 / 2 ) < ζ$$
as recited in claim 8 can be approximated by
$${min}_{1 \leq p \leq ( N - 1 )} {\sum }_{q = 1}^{N} {m}_{pq}^{2}$$
for high level tradeoff against N.

10. The estimate obtained in claim 7 can be further refined to gain more accuracy by employing θₖⱼ, the angle of Zₖⱼ, in which d_{N}<kⱼ<K as follows:
$${ϑ}_{kj} = arg ( {Z}_{kj} {e}^{- j2 π \hat{f} {k}_{j} \check{T}} ) ,$$
$$δ {f}_{kj} = {ϑ}_{kj} / 2 π {k}_{j} \check{T} ,$$
$$\hat{f} ← \hat{f} + ( {\sum }_{j = 1}^{j} δ {f}_{kj} ) / ( J + 1 ) .$$

11. A true robust frequency estimation is obtained in two stages. The first stage is aimed at obtaining a highly reliable n_{N} with smaller time lag phases. It resolves the phase ambiguity reliably when it occurs. The second stage is the estimation refinement using one or more larger time lags to enhance the accuracy. Depending on the requirements, the refinement stage can be optional.

12. The Diophantine framework in claim 6 facilitates a platform for computational tradeoff via trading d_{N} vs. N where d_{N} is the time lag baseline for estimate computation and N is the number of phase measurements.

13. The Diophantine framework in claim 6 is applicable to any problems that can be formulated by a set of relatively prime integers {dᵢ, i=1, 2, . . . , N} as ϕᵢ=mod (f(χ)dᵢ|Θ), where Θ is the moduli of the measurement ϕᵢ, and f(χ) is an invertible function of the parameter χ to be estimated. The applications in addition to the CFO estimation may include, but not limited to, radar ranging, angle of arrival of RF signals, and clock/oscillator synchronization, etc.
